(19) United States
(12) Patent Application Publication
(10) Pub. No.: US 2006/0124187 A1
(43) Pub. Date: Jun. 15, 2006

(54) Helical formation for a conduit

(75) Inventors: John Graeme Houston, Perth (GB); Robert Gordon Hood, Longforgan (GB); Peter Arno Stonebridge, Perth (GB)

Correspondence Address: DEMONT & BREYER, LLC, SUITE 250, 100 COMMONS WAY, HOLMDEL, NJ, 07733, US

(73) Assignee: Tayside Flow Technologies Limited, Dundee (GB)

(21) Appl. No.: 10/535,600

(22) PCT Filed: Nov. 13, 2003
(86) PCT No.: PCT/GB03/04917

§ 371 Date: Oct. 3, 2005

(30) Foreign Application Priority Data
Nov. 23, 2002 (GB) 0227369.6

(51) Int. Cl. F15D 1/04

(52) U.S. Cl. 138/39; 138/112; 138/129; 623/1.22; 623/1.32; 623/1.33

(57) ABSTRACT

A helical formation for a conduit (1). The helical formation includes an elongate member (4) defining at least a portion of a helix, the elongate member (4) comprising an inwardly extending portion (6, 7). The inwardly extending portion (6, 7) extends along the length of the elongate member (4) and extends inwardly from the internal side walls of the conduit (1) for a distance equal to between 10% and 80% of the distance (r) from the longitudinal axis (3) of the conduit (1) to an internal side wall (2).

The invention relates to a helical formation for a conduit.

A number of documents have proposed using helical formations in conduits to encourage a desired flow pattern of a fluid within the conduit. Such helical formations have been proposed for a wide variety of applications, including pipelines and blood flow tubing. The purpose of the helical formations is generally to generate spiral flow of the fluid within the conduit to reduce turbulence and dead spots within the conduit.

Although the use of helical formations has been proposed as beneficial to fluid flow in conduits by helping to generate spiral fluid flow patterns, there is little or no information on the physical characteristics of the helical formation that is required to create a suitable spiral flow pattern. Clearly, some designs of helical formations will be ineffective at creating spiral flow and other will not create a beneficial spiral flow. For example, helical formations having a high helix angle may tend to create turbulence rather than spiral flow due.

In accordance with a first aspect of the present invention, there is provided a helical formation for a conduit, the helical formation comprising an elongate member defining at least a portion of a helix, the elongate member comprising an inwardly extending portion, the inwardly extending portion extending along the length of the elongate member and extending inwardly from the internal side walls of the conduit for a distance equal to between 10% and 80% of the distance from the longitudinal axis of the conduit to an internal side wall.

The terms “helical”, “helix” and “spiral” as used herein cover the mathematical definition of helical and any combination of the mathematical definitions of helical and spiral.

Typically, the inwardly extending portion extends inwardly for a distance equal to between 40% and 70% of the distance from the longitudinal axis of the conduit to an internal side wall. Preferably, for a distance equal to between 40% and 60%, more preferably, for a distance equal to between 45% and 55%. Most preferably, the inwardly extending portion extends inwardly for a distance equal to substantially 50% of the distance from the longitudinal axis of the conduit to an internal side wall. Where the conduit has a circular cross-section, the distance is as a percentage of the radius of the conduit.

The helical formation may be in the form of an insert adapted to be inserted into the conduit, in use. The insert may be removably inserted or may be permanently inserted.

Alternatively, the helical formation may be an integral part of a side wall of the conduit. For example, the helical formation may be formed by a deformation of a portion of the side wall of the conduit.

In one example of the invention, the helical formation may be for use in blood flow tubing for the human or animal body. The tubing may be synthetic or natural blood flow tubing. For example, the tubing may be a graft. In another example, the conduit may be a stent for insertion into blood flow tubing in the human or animal body.

The helical formation may comprise two or more inwardly extending formations, arranged in side-by-side relationship extending along the length of the elongate member.

Examples of a helical formation in accordance with the invention will now be described with reference to the accompanying drawings, in which:

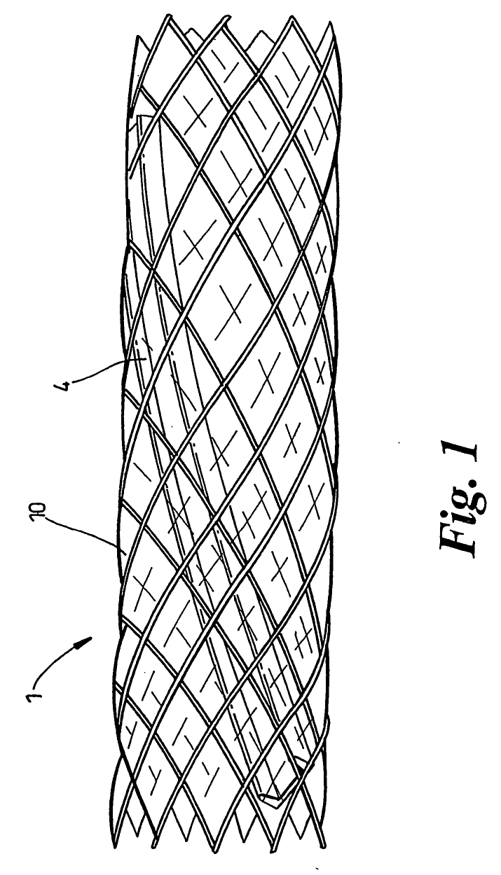

FIG. 1 is a perspective view of a stent having a first example of a helical formation;

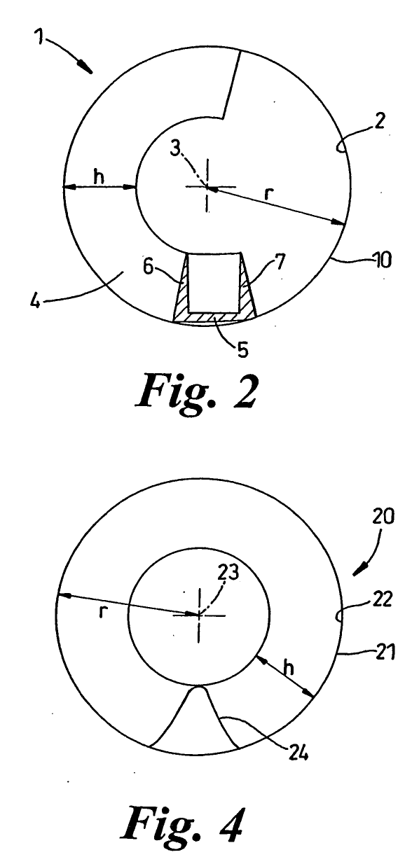

FIG. 2 is a cross-sectional view of the stent;

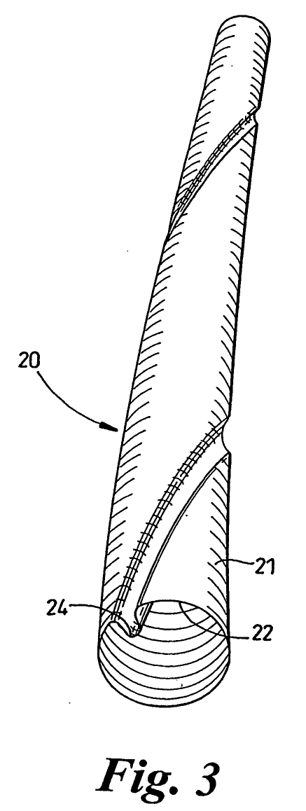

FIG. 3 is a perspective view of an arterial graft having a second example of a helical formation; and

FIG. 4 is a cross-sectional view of the graft.

FIGS. 1 and 2 show a stent 1 having a body section 10 with an internal surface 2 and a longitudinal axis 3. The body section 10 has a circular cross-section. The body section 10 typically, has a mesh construction and may be, for example a metallic mesh. The distance r from the longitudinal axis 3 to the internal surface 2 is the internal radius of the stent 1. Within the stent 1 is a helical formation in the form of an insert 4. The insert 4 is helically shaped and defines a helix around the longitudinal axis 3. The insert 4 comprises a base portion 5 and two inwardly extending fins 6, 7, which extend along the length of the insert 4. The insert 4 is generally formed from a biocompatible material, such as polyurethane and may be melted onto the mesh structure of the stent 1 so that the material of the stent 1 is entrained within the material of the insert 4.

Each of the fins 6, 7 extend by a height h from the internal surface 2. The height h of the fins 6, 7 is equal to 50% of the internal radius, r. That is, h=r/2.

FIGS. 3 and 4 show an arterial graft 20 for blood flow tubing for use in the human or animal body. The graft 20 comprises a body section 21 having an internal surface 22 and a longitudinal axis 23. The graft 20 has internal radius r from the longitudinal axis to the internal surface 22. The body section 21 is typically formed from a biocompatible material, such as woven or knitted polyester. A helical formation 24 is formed by a deformation of the side wall of the body section 21. The helical formation 24 extends inwardly by a height h from the internal surface 22 and extends along the length of the graft 20 to define a helix around the longitudinal axis 23.

In the graft 20, the height, h, of the helical formation 24 equals 50% of the internal radius, r. That is, h=r/2 for the graft 20.

The inventors have found that a height h equal to r/2 (or 50% of the radius) is particularly advantageous for generating spiral flow of blood within the stent 1 or the graft 20. They have also found that if the height h is too small, a negligible spiral flow pattern is produced by the insert 4 and the helical formation 24. In contrast, if the height h is too large relative to the internal radius r, the fins 6, 7 or the helical formation 24 tend to obturate the stent 1 or graft 20, respectively, and have a restrictive effect on flow.

While a height h=r/2 has been found to be produce a desired spiral flow pattern of blood in blood flow tubing, such as grafts and stents, the inventors have also found that other helical formation heights also have advantages in promoting spiral flow patterns. Therefore, the height h of the helical formation is typically, between 10% and 80% of the internal radius r, preferably, between 20% and 70%, more preferably between 40% and 60% and most preferably between 45% and 55%.

1. A helical formation for a conduit, the helical formation comprising an elongate member defining at least a portion of a helix, the elongate member comprising an inwardly extending portion, the inwardly extending portion extending along the length of the elongate member and extending inwardly from the internal side walls of the conduit for a distance equal to between 10% and 80% of the distance from the longitudinal axis of the conduit to an internal side wall.

2. A helical formation according to claim 1, wherein the inwardly extending portion extends inwardly for a distance equal to between 40% and 70% of the distance from the longitudinal axis of the conduit to an internal side wall.

3. A helical formation according to claim 2, wherein the inwardly extending portion extends inwardly for a distance equal to between 40% and 60%.

4. A helical formation according to claim 3, wherein the inwardly extending portion extends inwardly for a distance equal to between 45% and 55%.

5. A helical formation according to claim 4, wherein the inwardly extending portion extends inwardly for a distance equal to substantially 50% of the distance from the longitudinal axis of the conduit to an internal side wall.

6. A helical formation according to claim 1, wherein the conduit has a circular cross-section, and the distance that the inwardly extending portion extends inwardly is a percentage of the radius of the conduit.

7. A helical formation according to claim 1, the helical formation comprising two or more inwardly extending formations, arranged in side-by-side relationship extending along the length of the elongate member.

8. A conduit comprising a helical formation according to claim 1, wherein the helical formation is mounted on a side wall of the conduit.

9. A conduit according to claim 8, wherein the helical formation is in the form of an insert adapted to be inserted into the conduit.

10. A conduit according to claim 9, wherein the insert is removable from the conduit.

11. A conduit according to claim 8, wherein the helical formation is an integral part of a side wall of the conduit.

12. A conduit according to claim 11, wherein the helical formation is formed by a deformation of a portion of the side wall of the conduit.

13. A conduit according to claim 8, wherein the conduit comprises blood flow tubing for use in the human or animal body.

14. A conduit according to claim 13, wherein the blood flow tubing may comprise a vascular graft.

15. A conduit according to claim 8, wherein the conduit comprises a stent for insertion into blood flow tubing in the human or animal body.
